(19) United States
(12) Patent Application Publication
(10) Pub. No.: US 2014/0055557 A1
(43) Pub. Date: Feb. 27, 2014

(54) AUTOMATED EXTERNAL DEFIBRILLATOR WITH PANORAMIC VIDEO CAMERA DEVICE

(71) Applicant: CHUNG YUAN CHRISTIAN UNIVERSITY, Chung Li (TW)

(72) Inventors: Cheng-Lun TSAI, Jhongli City (TW); Kang-Ping LIN, Zhongli City (TW); Hen-Hong CHANG, Guishan Township (TW); Chi-Ping TAI, Chung Li (TW); Wen-Chih LIN, Miaoli City (TW)

(73) Assignee: CHUNG YUAN CHRISTIAN UNIVERSITY, Chung Li (TW)

(21) Appl. No.: 13/831,108

(22) Filed: Mar. 14, 2013

(30) Foreign Application Priority Data
Aug. 24, 2012 (TW) 101216348

(51) Int. Cl. H04N 5/232

(52) U.S. Cl. CPC H04N 5/23238
USPC 348/36

(57) ABSTRACT

An automated external defibrillator (AED) with a panoramic video camera device comprises a case, an AED accommodated by the case, a microprocessor built in the AED, an image capture device electrically connected with the microprocessor, a memory electrically connected with the microprocessor and storing the images captured by the image capture device, and a panoramic lens arranged above the image capture device. During usage, the present invention takes motion pictures panoramically to provide more detailed information for the medical personnel after the patient has been transported to the hospital and ascertain the truth for a medical dispute.

### BACKGROUND OF THE INVENTION

1. Field of the Invention

The present invention relates to an automated external defibrillator, particularly to an automated external defibrillator with a panoramic video camera device able to take motion pictures panoramically during first aid.

2. Description of the Related Art

An automated external defibrillator (AED) is a portable electronic device that automatically diagnoses the cardiac arrhythmias and applies electric shock to treat it, i.e. the so-called defibrillation. AED is normally designed to enable a medical layman to apply first aid to a person who is suffering from sudden cardiac arrest.

AEDs are usually deployed in the locations where large groups of people gather and a sudden cardiac arrest incident may take place, such as shopping centers, airports, stations, restaurants, stadiums, schools and EMS (Emergency Medical Service) centers. For Europeans and Americans, one in two dies of cardiovascular diseases. Therefore, AEDs are relatively popularized in Europe and America. In Asia, AEDs are extensively deployed in some high-populated areas, such as Japan and Hong Kong. In Taiwan, AEDs are only deployed in airports, high speed rail stations, rescue teams of fire offices, healthcare units of the army. Some airline companies have deployed AEDs in all their airliners. At present, AED cannot record images yet but can only record sounds. Thus, the medical personnel can only grasp limited information of the patient after the patient has been transported to the hospital. Besides, the sound record is less likely to ascertain the truth or identify the medical malpractice liability while there is a medical dispute. If the status of the patient, the process of first aid and the response of the patient can be recorded in detail, it should favor the medical personnel in diagnosis and treatment and help the experts identify the medical malpractice liability.

Accordingly, the present invention proposes an automated external defibrillator with a panoramic video camera device to overcome the abovementioned problems.

### SUMMARY OF THE INVENTION

The primary objective of the present invention is to provide an automated external defibrillator with a panoramic video camera device, wherein the video camera device has curved mirrors, whereby the video camera device can take the motion pictures of the surroundings of the defibrillator to record the events occurring during first aid, the recording might start right after AED is taken down from the shelf.

Another objective of the present invention is to provide an automated external defibrillator with a panoramic video camera device, wherein the panoramic video camera device can take motion pictures covering a larger angle of view in comparison with the common video camera device.

A further objective of the present invention is to provide an automated external defibrillator with a panoramic video camera device, wherein the motion pictures taken by the panoramic video camera device during first aid are replayed to help ascertain the truth while a medical dispute occurs.

To achieve the abovementioned objectives, the present invention proposes an automated external defibrillator with a panoramic video camera device, which comprises a case, an automated external defibrillator accommodated by the case, a microprocessor built in the automated external defibrillator, a memory electrically connected with the microprocessor, an image capture device electrically connected with the microprocessor, and a panoramic lens arranged above the image capture device. The microprocessor stores the images captured by the image capture device in the memory. Below, embodiments are described in detail in cooperation with drawings to make easily understood the characteristics and accomplishments of the present invention.

### BRIEF DESCRIPTION OF THE DRAWINGS

FIG. 1 is a perspective view schematically showing an automated external defibrillator with a panoramic video camera device according to one embodiment of the present invention;

FIG. 2 is a block diagram schematically showing the architecture of an automated external defibrillator with a panoramic video camera device according to one embodiment of the present invention;

FIG. 3 is a perspective view schematically showing an automated external defibrillator with a panoramic video camera device according to another embodiment of the present invention;

FIG. 4 is a diagram schematically showing a transparent body according to first embodiment of the present invention;

FIG. 5 is a diagram schematically showing a transparent body according to second embodiment of the present invention;

FIG. 6 is a diagram schematically showing the application of an automated external defibrillator with a panoramic video camera device according to one embodiment of the present invention.

### DETAILED DESCRIPTION OF THE INVENTION

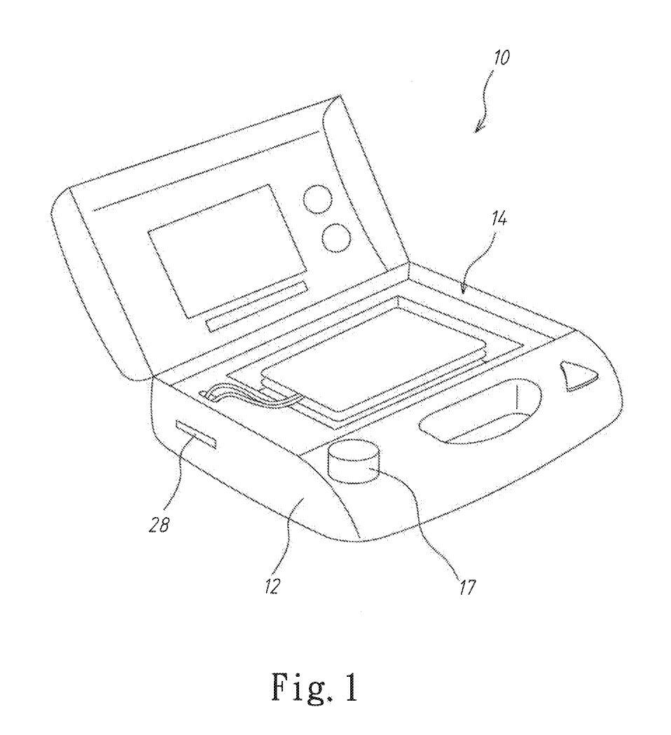

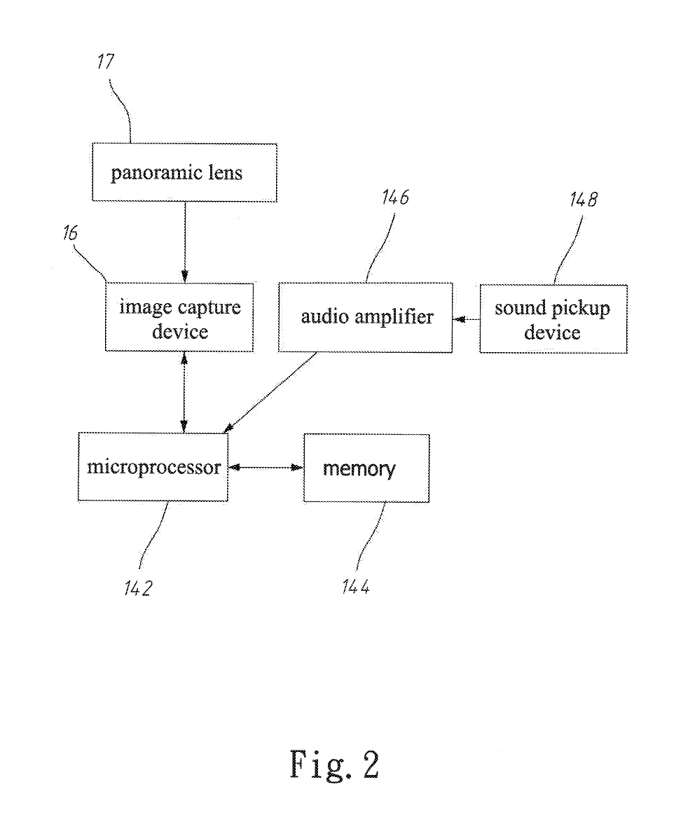

Refer to FIG. 1 and FIG. 2. The present invention discloses an “automated external defibrillator with a panoramic video camera device” 10, which comprises a case 12, an automated external defibrillator 14 accommodated by the case 12, a microprocessor 142 built in the automated external defibrillator 14, a memory 144 electrically connected with the microprocessor 142, an image capture device 16 electrically connected with the microprocessor 142, a panoramic lens 17 arranged above the image capture device 16, an audio amplifier 146 electrically connected with the microprocessor 142, and a sound pickup device 148 electrically connected with the audio frequency 146. The memory 144 is a memory built in the microprocessor 142 or an external memory inserted into a memory slot 28 electrically connected with the microprocessor 142. The image capture device 16 is CCD (Charge Coupled Device) or made of CMOS (Complementary Metal Oxide Semiconductor). The panoramic lens 17 is a fisheye lens or a transparent body whereby the image capture device 16 can capture panoramic images. In the embodiment shown in FIG. 1, the image capture device 16 and the panoramic lens 17 are arranged outside the case 12. Therefore, the automated external defibrillator with a panoramic video camera device 10 can start to capture the surrounding images for recording every event of the first aid even while the case 12 is still closed. The microprocessor 142 stores the images captured by the image capture device 16 in the memory 144. The sound pickup device 148 picks up sounds and electrically connects with an audio amplifier 146. The audio amplifier 146 further electrically connects with the microprocessor 142. The audio amplifier 146 amplifies the sound signals received by the sound pickup device 148 and sends the amplified sound signals to the microprocessor 142. The microprocessor 142 then stores the sound signals in the memory 144.

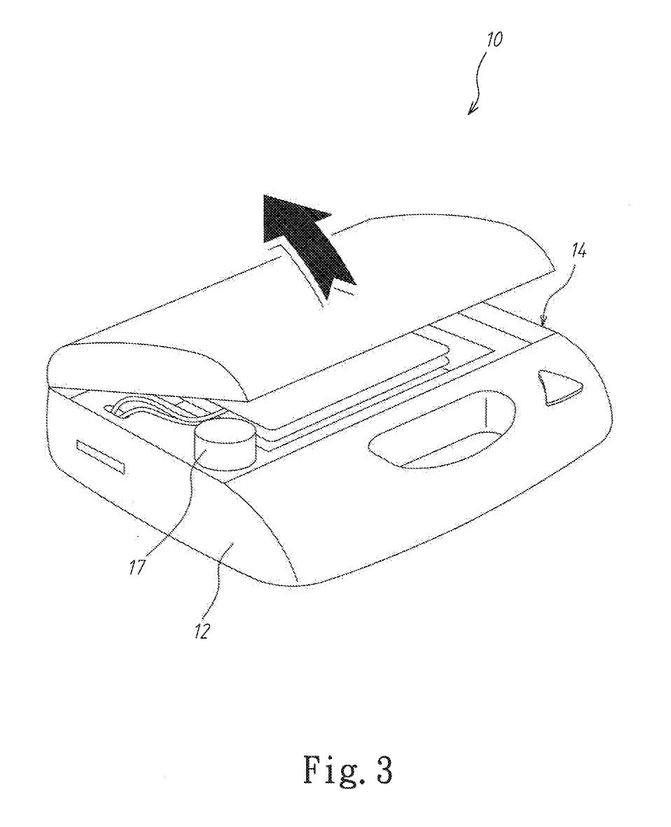

Refer to FIG. 3 for another embodiment of the present invention. In the embodiment shown in FIG. 3, the image capture device 16 and the panoramic lens 17 are arranged inside the case 12. Once the case 12 is opened, the image capture device 16 instantly gets ready to capture images lest the first responder waste precious time for first aid on adjusting the angle and altitude of the image capture device 16.

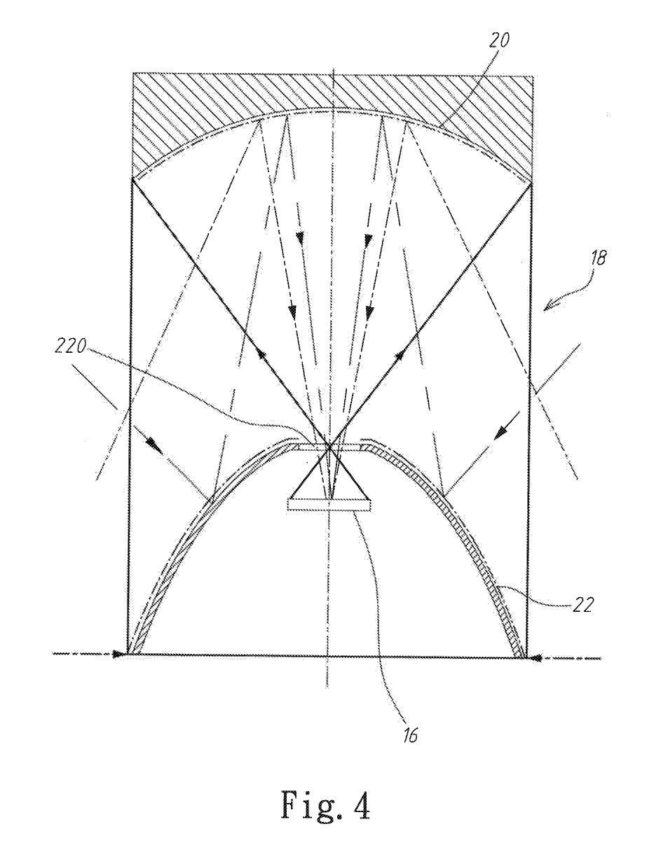

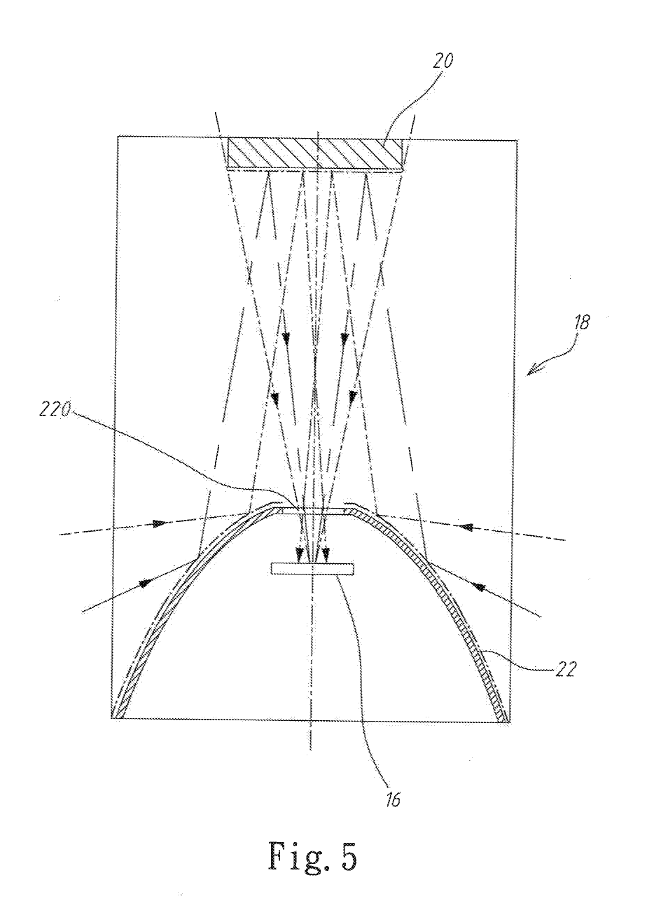

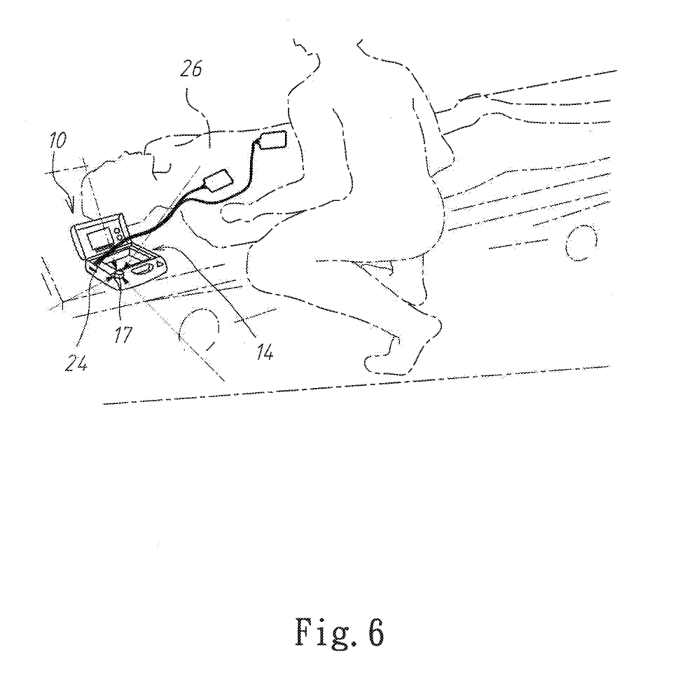

Refer to FIG. 4 is a diagram schematically showing a transparent body according to first embodiment of the present invention. The panoramic lens can be transparent body 18, transparent body 18 is arranged above the image capture device 16. Both sides of the transparent body 18 are transparent. The upper surface of the transparent body 18 has a first reflective layer 20, such as a smooth silver layer. As both sides of the transparent body 18 are transparent, external light can pass through the transparent body 18 and reach the first reflective layer 20. Therefore, the first reflective layer 20 can reflect the images of the surrounding objects like a mirror. The lower surface of the transparent body 18 has a second reflective layer 22, such as a smooth silver layer. The second reflective layer 22 can reflect the images of the objects outside two laterals of the transparent body 18 to the first reflective layer 20. The second reflective layer 22 has an opening 220 aligned to the lens of the image capture device 16. The first reflective layer 20 reflects the images, including the images directly coming from the exterior of the transparent body 18 and the images coming from the second reflective layer 22, to pass through the opening 220 and the lens of the image capture device 16. Thus, the image capture device 16 can simultaneously capture the once-reflected images and the twice-reflected images, wherein the once-reflected images directly come from the exterior and are reflected by the first reflective layer 20 only, and wherein the twice-reflected images are reflected by the second reflective layer 22 firstly and then reflected by the first reflective layer 20. Refer to FIG. 5 in one embodiment, the first reflective layer 20 is a plane mirror. In another embodiment, the first reflective layer 20 and the second reflective layer 22 are respectively a concave mirror and a convex mirror, which can reflect light beams of a larger field than a plane mirror. Via simultaneously capturing the once-reflected images and the twice-reflected images, the present invention can greatly expand the field of images captured by the image capture device. The concave mirror and convex mirror can further expand the field of images captured by the image capture device. Therefore, the present invention can take panoramic images in a greater angle of view. Refer to FIG. 6 schematically showing the application of the present invention. As the image capture device 16 and the panoramic lens 17 are arranged outside the case 12, the image capture device 16 can automatically takes motion pictures as soon as the AED with a panoramic video camera device 10 is taken out from the storage cabinet. The image capture device 16 will operate persistently until the first aid stops. Suppose that the image capture device 16 and the panoramic lens 17 are arranged inside the case 12, as shown in FIG. 3. While a patient 26 needs first aid, the first responder pulls out the AED 14 and attaches the electrodes of the AED 14 to the patient 26. If the AED 14 determines that the patient 26 needs electric shock, the image capture device 16 automatically takes panoramic motion pictures to record the events occurring during the first aid. Once a medical dispute occurs, the records can minimize indefiniteness and help ascertain the truth.

In the present invention, the automated external defibrillator has an image capture device equipped with curved mirrors, which occupy smaller volume but cover a larger field. Therefore, the present invention can take motion pictures panoramically around the automated external defibrillator. While a medical dispute occurs, the video information recorded by the present invention can be used to straighten out.

The embodiments described above are only to exemplify the present invention but not to limit the scope of the present invention. Any equivalent modification or variation according to the spirit of the present invention is to be also included within the scope of the present invention.

What is claimed is:

1. An automated external defibrillator with a panoramic video camera device, comprising
a case;
an automated external defibrillator arranged inside said case, wherein a microprocessor is built in said automated external defibrillator and electrically connected with a memory;
an image capture device electrically connected with said microprocessor, wherein said microprocessor stores images captured by said image capture device in said memory; and
a panoramic lens arranged above said image capture device.

2. The automated external defibrillator with a panoramic video camera device according to claim 1 further comprising an audio amplifier, wherein said audio amplifier is electrically connected with said microprocessor and a sound pickup device, and wherein said audio amplifier amplifies signals picked up by said sound pickup device and sends amplified signals to said microprocessor.

3. The automated external defibrillator with a panoramic video camera device according to claim 1, wherein said image capture device is CCD (Charge Coupled Device) or made of CMOS (Complementary Metal Oxide Semiconductor).

4. The automated external defibrillator with a panoramic video camera device according to claim 1, wherein said panoramic lens having a first reflective layer on an upper surface thereof and a second reflective layer on a lower surface thereof, wherein said second reflective layer has an opening aligned to a lens of said image capture device, and wherein said image capture device simultaneously captures images reflected by said first reflective layer and images reflected by said second reflective layer.

5. The automated external defibrillator with a panoramic video camera device according to claim 4, wherein said first reflective layer is a silver layer.

6. The automated external defibrillator with a panoramic video camera device according to claim 4, wherein said second reflective layer is a silver layer.

7. The automated external defibrillator with a panoramic video camera device according to claim 4, wherein said first reflective layer is a concave mirror or a convex mirror.

8. The automated external defibrillator with a panoramic video camera device according to claim 4, wherein said second reflective layer is a convex mirror.

9. The automated external defibrillator with a panoramic video camera device according to claim 1, wherein said panoramic lens is a fisheye lens.

10. The automated external defibrillator with a panoramic video camera device according to claim 1 further comprising at least one memory slot arranged on said automated external defibrillator and electrically connected with said microprocessor, wherein said memory is inserted into said memory slot.
